(19) United States
(12) Patent Application Publication
(10) Pub. No.: US 2022/0058721 A1
(43) Pub. Date: Feb. 24, 2022

(54) INFORMATION PROCESSING DEVICE AND INFORMATION PROCESSING METHOD

(71) Applicant: TOYOTA JIDOSHA KABUSHIKI KAISHA, Toyota-shi (JP)

(72) Inventors: Yurika TANAKA, Yokosuka-shi (JP); Shuichi SAWADA, Nagoya-shi (JP); Takaharu UENO, Nagoya-shi (JP); Shin SAKURADA, Toyota-shi (JP); Daiki YOKOYAMA, Gotemba-shi (JP); Genshi KUNO, Kasugai-shi (JP)

(73) Assignee: TOYOTA JIDOSHA KABUSHIKI KAISHA, Toyota-shi (JP)

(21) Appl. No.: 17/391,523

(22) Filed: Aug. 2, 2021

(30) Foreign Application Priority Data
Aug. 19, 2020 (JP) 2020-138713

(51) Int. Cl. G06Q 30/06; H04N 7/18

(52) U.S. Cl. CPC G06Q 30/0641; H04N 7/18; G06Q 30/0629; G06Q 30/0639

(57) ABSTRACT

An information processing device includes a control unit configured to execute detection that a first shopper has performed a specific behavior for a first product based on information acquired by a sensor, and determination of a reason why the first shopper has performed the specific behavior for the first product based on information related to the first product and at least one of information related to a second product that is a comparison target of the first product and information related to the first shopper.

### CROSS-REFERENCE TO RELATED APPLICATION

This application claims priority to Japanese Patent Application No. 2020-138713 filed on Aug. 19, 2020, incorporated herein by reference in its entirety.

### BACKGROUND

### 1. Technical Field

The present disclosure relates to an information processing device and an information processing method.

### 2. Description of Related Art

A system that tracks actual real-time shopper behavior data for an estimated position of a shopper in the store, time spent by the shopper for considering selection of a product, a location where the shopper spends the time, and a product selected and purchased by the shopper is disclosed (in, for example, Japanese Unexamined Patent Application Publication No. 2011-515758 (JP 2011-515758 A)).

### SUMMARY

However, for example, as a request from the store, there is a demand to know the reason why a shopper hesitates to purchase a product.

The present disclosure provides an information processing device and an information processing method capable of estimating the reason why a shopper hesitates to purchase a product.

A first aspect of the present disclosure relates to an information processing device. The information processing device includes a control unit configured to execute: detection that a first shopper has performed a specific behavior for a first product based on information acquired by a sensor; and determination of a reason why the first shopper has performed the specific behavior for the first product based on information related to the first product and at least one of information related to a second product that is a comparison target of the first product and information related to the first shopper.

According to the first aspect above, the control unit may be configured to determine the reason based on an attribute that makes a difference between the first product and the second product when the control unit determines the reason based on the information related to the first product and the information related to the second product.

According to the aspect above, the control unit may be configured to specify, as the second product, another product for which the first shopper has performed the specific behavior.

According to the aspect above, the control unit may be configured to specify, as the second product, a product displayed around the first product.

According to the aspect above, the control unit may be configured to specify, as the second product, a product that is preset as a comparison target of the first product.

According to the aspect above, the control unit may be configured to determine the reason based on an attribute that makes a difference between the first product and an orientation indicated by the information related to the first shopper when the control unit determines the reason based on the information related to the first product and the information related to the first shopper.

According to the aspect above, the control unit may be configured to further execute acquisition of attribute information on the first shopper acquired from an appearance as the information related to the first shopper based on an image including the first shopper, the image being captured by a camera serving as the sensor.

According to the aspect above, the control unit may be configured to further execute acquisition of purchase history information on the first shopper as the information related to the first shopper.

According to the aspect above, the control unit may be configured to detect that the first shopper has performed the specific behavior for the first product when the number of times that the first shopper picks up the first product is equal to or more than a threshold, the number of times being indicated by the information acquired by the sensor.

According to the aspect above, the control unit may be configured to detect that the first shopper has performed the specific behavior for the first product when a total time during which the first shopper carries the first product is equal to or more than a threshold, the total time being indicated by the information acquired by the sensor.

A second aspect of the present disclosure relates to an information processing method. The information processing method includes detecting that a first shopper has performed a specific behavior for a first product based on information acquired by a sensor; and determining a reason why the first shopper has performed the specific behavior for the first product based on information related to the first product and at least one of information related to a second product that is a comparison target of the first product and information related to the first shopper.

According to the second aspect above, when the reason is determined based on the information related to the first product and the information related to the second product, the reason may be determined based on an attribute that makes a difference between the first product and the second product.

According to the above aspect, another product for which the first shopper has performed the specific behavior may be specified as the second product.

According to the above aspect, a product displayed around the first product may be specified as the second product.

According to the above aspect, a product that is preset as a comparison target of the first product may be specified as the second product.

According to the above aspect, when the reason is determined based on the information related to the first product and the information related to the first shopper, the reason may be determined based on an attribute that makes a difference between the first product and an orientation indicated by the information related to the first shopper.

According to the above aspect, the information processing method may further include acquiring attribute information on the first shopper acquired from an appearance as the information related to the first shopper based on an image including the first shopper, the image being captured by a camera serving as the sensor.

According to the above aspect, the information processing method may further include acquiring purchase history information on the first shopper as the information related to the first shopper.

According to the above aspect, it may be detected that the first shopper has performed the specific behavior for the first product when the number of times that the first shopper picks up the first product is equal to or more than a threshold, the number of times being indicated by the information acquired by the sensor.

According to the above aspect, it may be detected that the first shopper has performed the specific behavior for the first product when a total time during which the first shopper carries the first product is equal to or more than a threshold, the total time being indicated by the information acquired by the sensor.

According to the present disclosure, the reason why the shopper hesitates to purchase the product can be estimated.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing an example of a system configuration of a purchase consideration reason determination system according to a first embodiment;

FIG. 2 is an example of a hardware configuration of a center server, a camera, and a tag;

FIG. 3 is a diagram showing an example of functional configurations of the center server and the tag;

FIG. 4 is a diagram showing an example of a data structure of a product information database;

FIG. 5 is a diagram showing an example of a data structure of a tag information database;

FIG. 6 is an example of a data structure of a behavior history information database;

FIG. 7 is an example of a flowchart of a shopper monitoring process of the center server;

FIG. 8 is an example of a flowchart of a reason determination process of the center server;

FIG. 9 is a diagram showing an example of a data structure of a shopper attribute information database;

FIG. 10 is a diagram showing an example of a data structure of an orientation information database; and

FIG. 11 is a flowchart of a shopper monitoring process of the center server according to a second embodiment.

### DETAILED DESCRIPTION OF EMBODIMENTS

One aspect of the present disclosure provides an information processing device. The information processing device includes a control unit. The control unit detects that a first shopper has performed a specific behavior for a first product based on information acquired by a sensor. In addition, the control unit determines a reason why the first shopper has performed a specific behavior for the first product based on the information related to the first product and at least one of the information related to a second product that is a comparison target of the first product and the information related to the first shopper.

The information processing device is, for example, a computer that operates as a server. The control unit is, for example, a processor such as a central processing unit (CPU). However, the control unit is not limited to the CPU. The specific behavior by the first shopper is a behavior that tend to occur when a shopper hesitates to purchase a product. Examples of the behavior that tends to occur when the shopper hesitates to purchase a product include a behavior that the shopper repeatedly picks up the product and returns the product to the original position and a behavior that the shopper picks up the product and carries the product for a predetermined time. The sensor is, for example, a camera, an acceleration sensor or a gyro sensor, etc. The acceleration sensor or the gyro sensor is built in a tag attached to a product or a tool for displaying the product. The sensor is not limited to the above, and may be, for example, a mechanism capable of detecting that the product has been picked up by the shopper. The sensor may be used as one sensor or in combination of two or more sensors.

The control unit may determine, when the control unit determines the reason why the first shopper has performed a specific behavior for the first product based on the information related to the first product and the information related to the second product, the reason based on an attribute that makes a difference between the first product and the second product. Further, the control unit may determine, when the control unit determines the reason why the first shopper has performed a specific behavior for the first product based on the information related to the first product and the information related to the first shopper, the reason based on an attribute that makes a difference between the first product and an orientation indicated by the information related to the first shopper.

According to the present disclosure, when the first shopper has performed a specific behavior that tends to occur when the first shopper hesitates to purchase the first product, the reason why the first shopper has performed the specific behavior can be determined. The reason why the shopper performs a specific behavior for the first product is regarded as the reason why the shopper hesitates to purchase the first product and can be used for determining a sales promotion policy of the first product, creating an idea of store display, developing new products, etc.

The attributes of the product and the orientation are determined, for example, based on types of the product. For example, when the product is clothes, the attributes of the product and the orientation include a price, material, design, size, color, etc. For example, when the product is an electric appliance, the attributes of the product and the orientation include a price, performance, function, design, size, color, etc. For example, when there is a difference in price between the first product and the second product, the control unit may determine that the reason why the first shopper performs a specific behavior for the first product is the price. For example, when there is a difference in design between the first product and the orientation indicated by the information related to the first shopper, the control unit may determine that the reason why the first shopper performs a specific behavior for the first product is the design.

The control unit may specify another product for which the first shopper has performed a specific behavior as the second product. Alternatively, the control unit may specify a product displayed around the first product as the second product. Alternatively, the control unit may specify a product that is preset as a comparison target of the first product as the second product. The product that is preset as the comparison target of the first product includes, for example, a product having an actual record of comparison with the first product, or a product that sells best in the same category as the first product.

When a product displayed around the first product or a product that is preset as a comparison target is specified as the second product, the product that is the comparison target can be specified even in the case where there is only one first product for which the first shopper has performed a specific behavior, which makes it possible to determine the reason why the first shopper performs a specific behavior for the first product.

The control unit may further execute acquisition of the attribute information on the first shopper acquired from an appearance as the information related to the first shopper based on the captured image, including the first shopper, that is captured by the camera serving as the sensor. Attribute information on the first shopper acquired from the appearance of the first shopper includes information such as gender, age, and body shape, for example. For example, the reason why the first shopper hesitates to purchase the product can be determined based on a difference between the attribute of the orientation of purchasers who are the same gender and age and have the same body shape as the first shopper and the attribute of the first product.

The control unit may further execute acquisition of purchase history information on the first shopper as the information related to the first shopper. The reason why the first shopper has performed a specific behavior for the first product can be determined based on the attribute that makes a difference between the attribute of the orientation of the product purchased by the first shopper in the past and the attribute of the first product.

Hereinafter, embodiments of the present disclosure will be described with reference to the drawings. The configurations of the following embodiments are illustrative, and the present disclosure is not limited to the configurations of the embodiments.

### First Embodiment

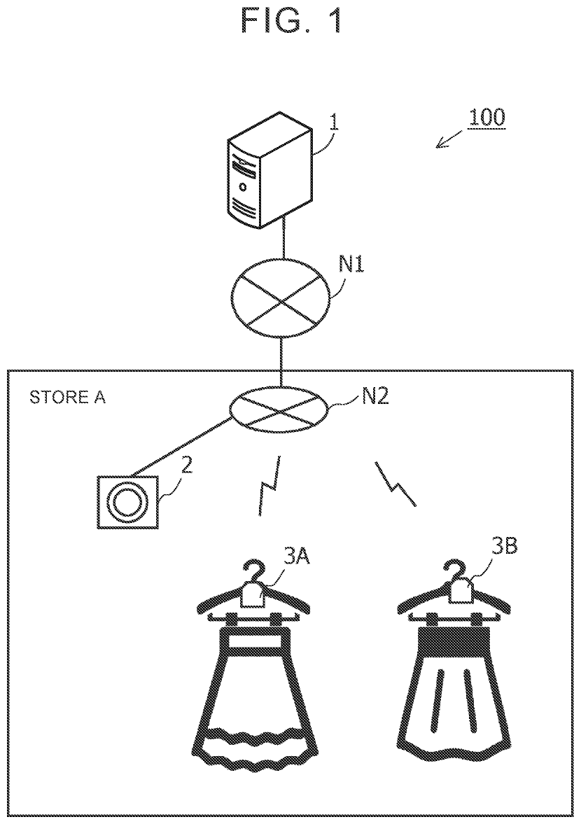

FIG. 1 is a diagram showing an example of a system configuration of a purchase consideration reason determination system 100 according to a first embodiment. The purchase consideration reason determination system 100 is a system that detects that a shopper has performed a specific behavior that tends to occur when the shopper hesitates to purchase the first product and determines the reason for the specific behavior. The purchase consideration reason determination system 100 includes, for example, a center server 1, a camera 2 installed in a store A, and a tag 3A and a tag 3B attached to respective products in the store A. Hereinafter, when the tag 3A and the tag 3B are not distinguished from each other, the tags 3A, 3B are simply referred to as a tag 3. The store A is a store that handles clothes as a product.

The center server 1 connects to a network N1. The camera 2 and the tag 3 are connected to a network N2 in the store A, are connected to the network N1 through the network N2, and are communicable with the center server 1. The network N1 is, for example, the Internet. The network N2 is, for example, a local area network (LAN).

The camera 2 is a camera of which imaging range is a space where the products are displayed in the store A. A plurality of the cameras 2 may be installed in accordance with the size of the display space where the products are displayed in the store A such that the imaging ranges of the cameras 2 differ from each other so as to monitor the entire display space. The camera 2 may be a camera having a fixed imaging range, or a camera having a variable imaging range by panning or tilting. The camera 2 captures images at a predetermined frame rate, for example, and transmits the captured images to the center server 1 in real time.

The tag 3 is a device installed on a hanger used for displaying clothes as a product. The tag 3 includes a sensor, and detects movement of the hanger as the shopper performs a behavior to pick up the product and performs a behavior to return the product to the display. Further, the tag 3 has a wireless communication function. When the tag 3 detects that the hanger has been moved, the tag 3 notifies the center server 1 of the movement of the hanger. Although the illustration of a wireless relay device is omitted in FIG. 1, the wireless relay device is installed in the store A, and is connected to the network N2. The tag 3 connects to the network N2 via the wireless relay device.

The center server 1 monitors the inside of the store A from the image captured by the camera 2. For example, the center server 1 tracks each shopper from the entry to and the exit from the store A using the images captured by the camera 2, and monitors the behavior of the shopper in the store A. For example, the center server 1 records the behavior of the shopper to pick up the product or the behavior to return the product to the display and the product as the behavior history of the shopper based on the behaviors of the shopper and the notification from the tag 3. The center server 1 determines, based on the recorded behavior history information on the shopper, whether there is a product that the shopper hesitates to purchase. For example, when there is a product that has been picked up by the shopper equal to or more than a predetermined number of times, or a product that has been held by the shopper in hand for a duration equal to or longer than a predetermined time, the detection is made that the shopper has performed a specific behavior for the product, and the determination is also made that the shopper hesitates to purchase the product. In the first embodiment, whether the shopper hesitates to purchase the product is irrelevant to whether the shopper actually purchases the product. Hereinafter, a product for which the shopper has performed a specific behavior that tends to occur when the shopper hesitates to purchase the product will be referred to as a purchase consideration product. The purchase consideration product is an example of the “first product”.

The center server 1 compares the information related to the purchase consideration product with the information related to a comparison target product, and determines the reason why the shopper has performed a specific behavior for the purchase consideration product based on a comparison difference. The reason why the shopper has performed a specific behavior for the purchase consideration product is, in other words, the reason why the shopper hesitates to purchase the purchase consideration product. If the reason why the shopper has performed a specific behavior for the purchase consideration product can be acquired, the reason why the shopper hesitates to purchase the purchase consideration product can also be acquired. Examples of the comparison target products include other purchase consideration products, a product displayed around the purchase consideration product, or a product preset as the comparison target in accordance with the category of the purchase consideration product. Examples of the product preset as the comparison target in accordance with the category of the purchase consideration product include, a product that sells best in the category, and a product having an actual record of comparison with the first product.

The difference between the purchase consideration product and the comparison target product is acquired with respect to each attribute of the product (clothes in the first embodiment) such as a price, design, color, size, and material. For example, when the shopper hesitates to purchase a product A or a product B having small difference in the price and color but large design difference, the design that is the attribute having a large difference is determined as the reason why the shopper hesitates to purchase the product.

According to the first embodiment, when there is a product that the shopper hesitates to purchase, the reason why the shopper hesitates to purchase the product can be determined. Specification of the reason why the shopper hesitates to purchase the product makes it possible to acquire the information on the attribute that affects decision making by the shopper to purchase the product, for example, and the information can be utilized for sales promotion, product development, etc.

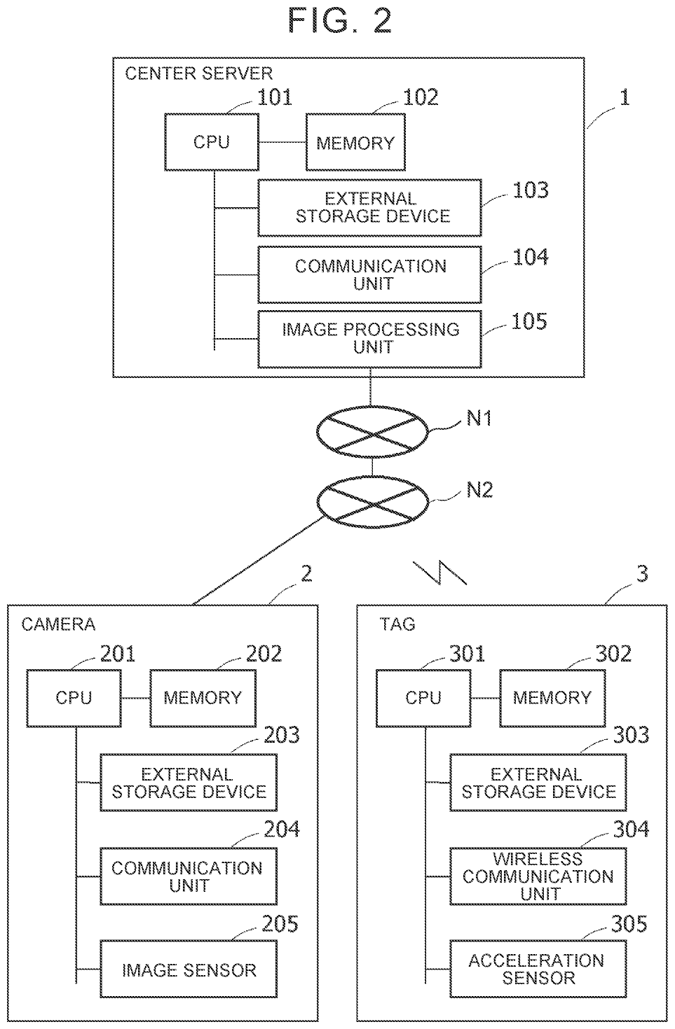

FIG. 2 is an example of a hardware configuration of the center server 1, the camera 2, and the tag 3. The center server 1 includes a CPU 101, a memory 102, an external storage device 103, a communication unit 104, and an image processing unit 105 as the hardware configurations. The memory 102 and the external storage device 103 are computer-readable recording media. The center server 1 is an example of the “information processing device”.

The external storage device 103 stores various programs and data used by the CPU 101 when the CPU 101 executes each program. The external storage device 103 is, for example, an erasable programmable ROM (EPROM) or a hard disk drive (HDD). The program stored in the external storage device 103 includes, for example, an operating system (OS), a control program of the purchase consideration reason determination system 100, and various other application programs.

The memory 102 is a storage device that provides the CPU 101 with a storage area and a work area for loading the program stored in the external storage device 103, and that is used as a buffer. The memory 102 includes, for example, a semiconductor memory such as a read-only memory (ROM) or a random access memory (RAM).

The CPU 101 executes various processes by loading the OS and various application programs stored in the external storage device 103 into the memory 102 and executing the OS and the various application programs. The number of CPUs 101 is not limited to one, and a plurality of the CPUs 101 may be provided. The CPU 101 is an example of the “control unit”.

The communication unit 104 is, for example, a wired network card such as a LAN or a dedicated line, and connects to the network N1 through an access network such as the LAN. The hardware configuration of the center server 1 is not limited to that shown in FIG. 2.

The camera 2 includes, for example, a CPU 201, a memory 202, an external storage device 203, a communication unit 204, and an image sensor 205 as the hardware configurations.

The CPU 201 and the memory 202 are the same as the CPU 101 and the memory 102, respectively. Therefore, the description thereof will be omitted. The external storage device 203 is, for example, a flash memory or a portable recording medium such as a secure digital (SD) memory card. The communication unit 204 is, for example, a LAN card that connects to the LAN in the store A. However, the communication unit 204 is not limited to the LAN card, and may be a wireless communication circuit corresponding to a predetermined wireless communication method. The image sensor 205 is, for example, an image sensor such as a charge coupled device (CCD) or a complementary metal oxide semiconductor (CMOS).

The tag 3 includes a CPU 301, a memory 302, an external storage device 303, a wireless communication unit 304, and an acceleration sensor 305 as the hardware configurations. The CPU 301, the memory 302, and the external storage device 303 are the same as the CPU 101, the memory 102, and the external storage device 203, respectively, and thus the description thereof will be omitted.

In the first embodiment, the wireless communication unit 304 is a wireless communication circuit corresponding to a wireless communication method such as WiFi. However, the wireless communication unit 304 is not limited to the above, and may be a wireless circuit corresponding to a short-range wireless communication system in the Bluetooth (registered trademark) low energy (BLE) band, the low frequency (LF) band, the high frequency (HF) band, the ultra high frequency (UHF) band, or the microwave band. The acceleration sensor 305 detects the acceleration applied to the tag 3. The tag 3 may be equipped with a gyro sensor in place of or in addition to the acceleration sensor 305.

The hardware configurations of the center server 1, the camera 2, and the tag 3 are not limited to those shown in FIG. 2.

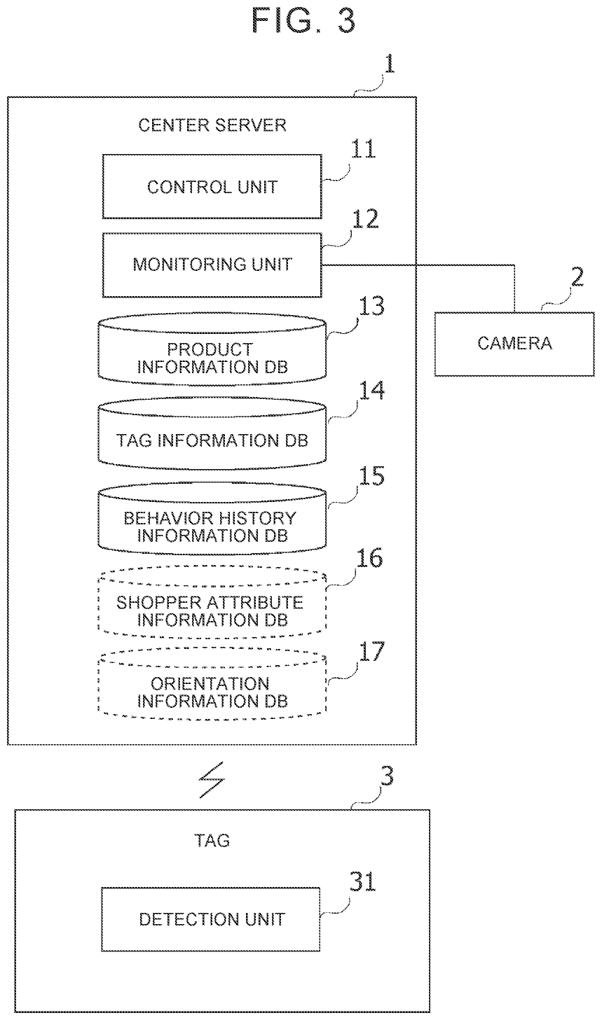

FIG. 3 is a diagram showing an example of functional configurations of the center server 1 and the tag 3. The tag 3 includes a detection unit 31 as the functional configuration. The detection unit 31 is, for example, a functional component achieved in a manner such that the CPU 301 of the tag 3 executes a predetermined program stored in the external storage device 303.

The detection unit 31 receives, for example, the detection value of the acceleration sensor 305 and detects movement of the tag 3. When the detection unit 31 detects movement of the tag 3, for example, the detection unit 31 determines a type of movement based on the detection value of the acceleration sensor 305. The types of movement of the tag 3 determined by the detection unit 31 include, for example, movement in which the hanger to which the tag 3 is attached is removed from the hanger pole, and movement in which the hanger to which the tag 3 is attached is hung on the hanger pole.

The movement in which the hanger to which the tag 3 is attached is removed from the hanger pole indicates that, in the first embodiment, the product is picked up by the shopper. The movement in which the hanger to which the tag 3 is attached is hung on the hanger pole indicates that, in the first embodiment, the product is returned to the display by the shopper. The types of movement of the tag 3 detected by the detection unit 31 are not limited to the above. Hereinafter, the type of movement of the tag 3 when the product is picked up by the shopper and picking up of the product by the shopper will be referred to as “pickup”. Further, the type of movement of the tag 3 when the product is returned to the display by the shopper and returning of the product to the display by the shopper will be referred to as “return”.

When the detection unit 31 detects, for example, the pickup and the return as the type of movement of the tag 3, the detection unit 31 transmits identification information of the tag 3 itself and information indicating the type of movement of the tag 3 to the center server 1 as tag movement information. The tag movement information may include a time stamp at which the tag movement is detected. The information indicating the type of movement is a text, a code, or a flag indicating the type of movement.

The center server 1 includes a control unit 11, a monitoring unit 12, a product information database (DB) 13, a tag information DB 14, and a behavior history information DB 15 as functional configurations. Shopper attribute information DB 16 and orientation information DB 17 are not used in the first embodiment, and therefore will be described later. The functional components above are achieved, for example, in a manner such that the center server 1 executes a predetermined program such as a control program of the purchase consideration reason determination system 100.

The monitoring unit 12 receives the captured image from the camera 2. The monitoring unit 12 identifies the shopper by image recognition processing based on the image captured by the camera 2, tracks the shopper, and monitors the behavior of the shopper in the store A. Even when the plurality of cameras 2 is installed, the monitoring unit 12 identifies each shopper from the images captured by each camera 2 and monitors the behavior of each shopper.

Further, the monitoring unit 12 receives the tag movement information from the tag 3. The monitoring unit 12 detects a behavior event of the shopper based on a recognition result of the image captured by the camera 2 and the tag movement information from the tag 3. The types of behavior events of the shopper include, for example, the entry to the store A, the exit from the store A, the pickup and the return of the product, and purchase of the product.

For example, the entry to and the exit from the store A are detected by image recognition of the image captured by the camera 2. The pickup and the return of the product are detected by a combination of detection of movement of the shopper based on the recognition result of the image captured by the camera 2 and the tag movement information. For example, the monitoring unit 12 detects that the shopper picks up the product when the monitoring unit 12 detects the behavior of the shopper to pick up the product hung on the hanger based on the recognition result of the image captured by the camera 2, and at the same time, receives the tag movement information in which the type of movement is “pickup” from the tag 3. The purchase of the product is detected, for example, based on the recognition result of the image captured by the camera 2 and payment information of a cash register.

When the monitoring unit 12 detects the behavior event of the shopper, the monitoring unit 12 generates the behavior history information and stores the generated information in the behavior history information DB 15. The details of the behavior history information DB 15 will be described later.

When the control unit 11 detects that the shopper has performed a specific behavior for a predetermined product based on the behavior history information, the control unit 11 determines the reason for the behavior, thereby determining the reason why the shopper hesitates to purchase the product. First, the control unit 11 detects, from the behavior history information, that the shopper has performed a specific behavior for a predetermined product. Performing a specific behavior can be detected based on the fact that the number of times the shopper picks up one product is equal to or more than a threshold, and/or that the time during which the shopper carries the product is equal to or more than a threshold, for example. Conditions for determining that the shopper has performed a specific behavior for a predetermined product are not limited to the above. For example, when the product is clothes, an event that the shopper tries the clothes on may be used as the condition for determining that the shopper has performed a specific behavior.

When the control unit 11 detects that the shopper has performed a specific behavior for a predetermined product, the control unit 11 specifies the comparison target of the purchase consideration product. For example, when there is a plurality of purchase consideration products for one shopper, other purchase consideration products with respect to one purchase consideration product are comparison targets. That is, when there is a plurality of purchase consideration products for one shopper, the control unit 11 performs a comparison among the purchase consideration products.

When there is only one purchase consideration product, a product displayed around the purchase consideration product, for example, is specified as the comparison target. For example, among the products displayed next to the purchase consideration product or the products displayed in an area where the purchase consideration product is displayed, the products having similar characteristics are specified as the comparison targets. Alternatively, the best-selling product in the same category as the purchase consideration product may be specified as the comparison target. Alternatively, the product preset as the comparison target in the same category as the purchase consideration product may be specified as the comparison target. The product preset as the comparison target may be a virtual product that is not actually on sale.

The control unit 11 compares the purchase consideration product with the comparison target and acquires a difference of each attribute. This is because it is considered that the shopper becomes hesitant about purchase of the product due to the difference between the purchase consideration product and the other products. For example, when the product is clothes, the attributes of the product include a price, design, material, size, and color.

The control unit 11 determines the reason why the shopper has performed a specific behavior based on the difference. For example, the control unit 11 determines the attribute having a difference as the reason why the shopper has performed a specific behavior. When there is a plurality of the attributes having a difference, the attributes may be determined as the reason why the shopper has performed a specific behavior. Alternatively, an attribute having a difference larger than a predetermined value may be determined as the reason why the shopper has performed a specific behavior. Attributes that are not indicated by numerical values may be quantified in accordance with a predetermined method, and the difference may be acquired. Further, the reason why the shopper has performed a specific behavior may be acquired by inputting the numerical value of each attribute of the purchase consideration product into a learned model and acquiring the reason as an output from the learned model.

The determination result of the reason why the shopper has performed a specific behavior is output to, for example, a predetermined output destination. The predetermined output destination is, for example, a display, a storage area, or another server.

The process of determining the reason why the shopper has performed a specific behavior is executed, for example, at a predetermined timing. The process of determining the reason why the shopper has performed a specific behavior may be executed by batch processing, for example, at a predetermined time or when an instruction to start the process is input. Alternatively, for example, the process of determining the reason why the shopper has performed a specific behavior may be executed at a predetermined timing at which it is determined that the shopper has performed a specific behavior by processing the behavior history information on the shopper in real time.

The product information DB 13, the tag information DB 14, and the behavior history information DB 15 are created in the storage area of the external storage device 103 of the center server 1. The product information DB 13 stores information related to the product. The tag information DB 14 stores information related to the tag 3. The behavior history information DB 15 stores the behavior history information.

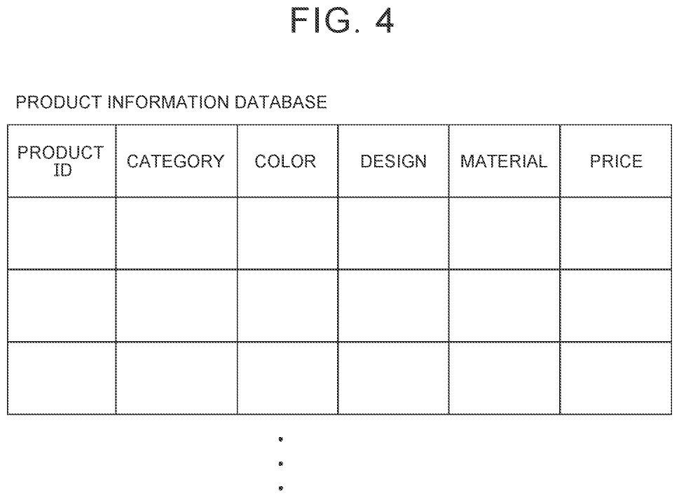

FIG. 4 is a diagram showing an example of the data structure of the product information DB 13. The product information DB 13 stores the information related to the product. FIG. 4 shows the example of the data structure of the product information DB 13 when the product is the clothes.

A record (also referred to as an entry) of the product information DB 13 includes fields of a product identification (ID), category, color, design, material, and price. The identification information of the product is stored in the product ID field. The identification information of the product does not have to identify individual clothes, for example. For example, the same identification information may be used for products having the same attributes.

Information indicating the category of the product is stored in the category field. When the product is clothes, the category of the product includes, for example, outerwear, tops, trousers, skirts, dresses, shoes, bags, and accessories. In addition, sub-categories that are further subdivided may be provided for each category.

Information indicating the color is stored in the color field. Information indicating the design is stored in the design field. The design is, for example, information related to the design such as a textile, a designer, or a series. Information related to the material of the product is stored in the material field. The price of the product is stored in the price field.

The color, design, material, and price are each one of the attributes of the product (in the case of clothes). The product information DB 13 is prepared in advance for each store, for example. The data structure of the product information DB 13 is not limited to that shown in FIG. 4, and is appropriately set in accordance with the product or depending on what type of attribute the reason why the shopper hesitates to purchase the product is determined. For example, when it is desired to consider the size, weight, etc., as the attributes of the product for determining the reason why the shopper has performed a specific behavior for the product, size and weight fields may be added to the product information DB 13. Further, the product information DB 13 does not have to be under the control of the center server 1. For example, the product information DB held by each store may be used.

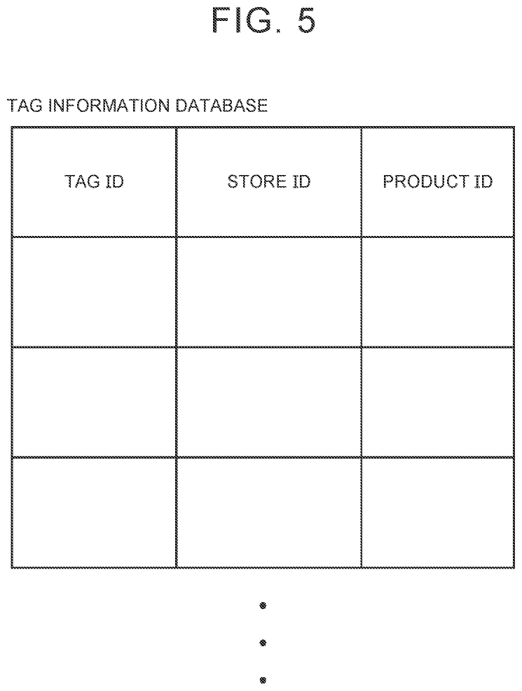

FIG. 5 is a diagram showing an example of the data structure of the tag information DB 14. The tag information DB 14 stores the information related to the tag 3. The entry of the tag information DB 14 includes fields of a tag ID, a store ID, and the product ID.

The identification information of the tag 3 is stored in the tag ID field. The identification information of the store is stored in the store ID field. The identification information of the product to which the tag 3 is attached is stored in the product ID field. In the tag information DB 14, for example, when a tag 3 is attached to a product, a staff of the store associates the tag 3 with the product, and the association is notified to the center server 1 through the terminal of the store.

The data structure of the tag information DB 14 is not limited to that shown in FIG. 5. For example, the tag information DB 14 may store information indicating a placement position of the product to which the tag 3 is attached. For example, the information indicating the placement position of the product to which the tag 3 is attached is the identification information of the display space where the product is displayed when the store A is divided based on the display space. When the placement position of the product can be obtained in more detail, more detailed information may be used.

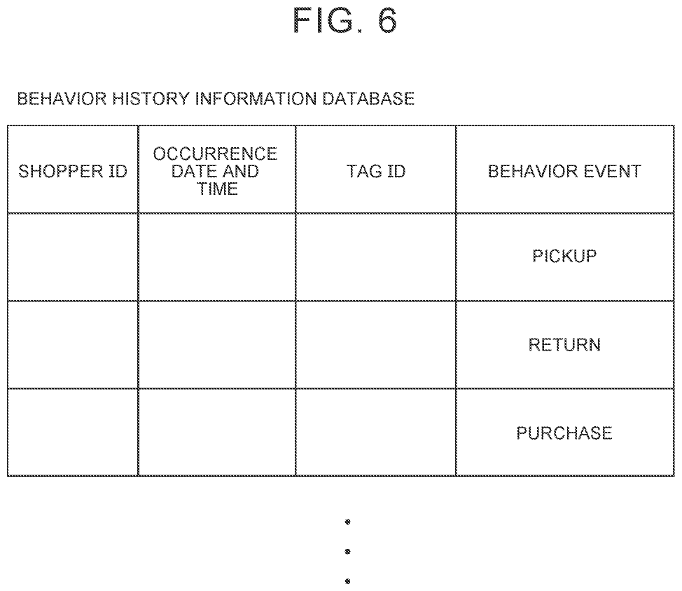

FIG. 6 is an example of the data structure of the behavior history information DB 15. The behavior history information DB 15 stores the behavior history information on the shopper in the store. The entry of the behavior history information DB 15 includes fields of a shopper ID, an occurrence date and time, the tag ID, and the behavior event.

The identification information of the shopper is stored in the shopper ID field. In the first embodiment, the personal information of the shopper is not used. Therefore, the identification information of the shopper is assigned by the center server 1 to identify the shopper while the shopper is in the store. Accordingly, in the first embodiment, even if the same person visits the same store on different days, different identification information of the shopper is assigned. However, in the case of a mode in which personal information is used, the identification information of the shopper stored in the shopper ID field, for example, is the identification information assigned to each shopper by the store.

In the occurrence date and time field, the date and time when the behavior of the shopper that triggers creation of the behavior history information are stored. For example, the time stamp of the image captured by the camera 2 may be adopted, or the time stamp assigned to the tag movement information from the tag 3 may be adopted. In the tag ID field, the identification information of the tag 3 related to the behavior event of the shopper that triggers creation of the behavior history information is stored. However, when the tag 3 is not related to the behavior event of the shopper that triggers creation of the behavior history information, the tag ID field is empty.

The information indicating the type of behavior event of the detected shopper is stored in the behavior event field. For example, the types of behavior events of the shopper include, for example, the pickup, return, purchase, entry, and exit. From the above, the types of behavior events related to the tag 3 are the pickup and the return. The data structure of the behavior history information DB 15 is not limited to that shown in FIG. 6.

### Process Flow

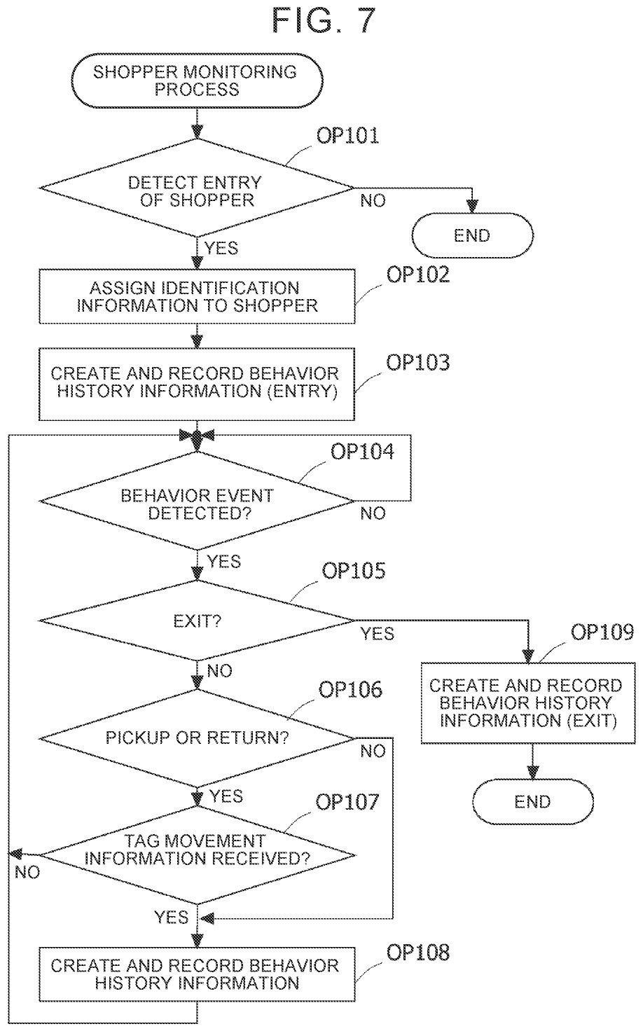

FIG. 7 is an example of a flowchart of a shopper monitoring process of the center server 1. The process shown in FIG. 7 is repeatedly executed, for example, at a predetermined cycle. Further, each time one shopper is detected, the processing process shown in FIG. 7 is started. The main body of execution of the process of the center server 1 shown in FIG. 7 and later is the CPU 101. However, for convenience, the functional components will be described as the main body. In FIG. 7, the store A will be described as an example.

In OP101, the monitoring unit 12 determines whether the entry of the shopper into the store A is detected from the image captured by the camera 2. When the monitoring unit 12 detects the entry of the shopper into the store A (OP101: YES), the process proceeds to OP102. When the monitoring unit 12 does not detect the entry of the shopper into the store A (OP101: NO), the process shown in FIG. 7 ends. After that, monitoring of the shopper who has been detected to enter the store A is started. The shopper to be monitored is hereinafter referred to as a target shopper.

In OP102, the monitoring unit 12 assigns the identification information to the target shopper. In OP103, the monitoring unit 12 creates the behavior history information including the identification information of the target shopper and the type of behavior event “entry”, and stores the information in the behavior history information DB 15.

In OP104, the monitoring unit 12 determines whether the behavior event of the target shopper is detected from the image captured by the camera 2. When the monitoring unit 12 detects the behavior event of the target shopper (OP104: YES), the process proceeds to OP105. When the behavior event of the target shopper is not detected (OP104: NO), the process in OP104 is repeated.

In OP105, the monitoring unit 12 determines whether the type of the detected behavior event is “exit”. When the type of behavior event is “exit” (OP105: YES), the process proceeds to OP109. In OP109, the monitoring unit 12 creates the behavior history information including the identification information of the target shopper and the type of behavior event “exit”, and stores the information in the behavior history information DB 15. After that, the process shown in FIG. 7 ends.

When the type of behavior event is not “exit” (OP105: NO), the process proceeds to OP106. In OP106, the monitoring unit 12 determines whether the type of the detected behavior event is “pickup” or “return”. When the type of detected behavior event is “pickup” or “return” (OP106: YES), the process proceeds to OP107. When the type of detected behavior event is not “pickup” or “return” (OP106: NO), the process proceeds to OP108.

In OP107, the monitoring unit 12 determines whether the tag movement information from the tag 3 is received. A positive determination is made in OP107 when, for example, two conditions are both satisfied, one of which being that the type of the behavior event detected in OP104 and the type of movement included in the tag movement information match each other, and the other of which being that the time stamp of the image captured by the camera 2 with which the behavior event is detected in OP104 and the time stamp included in the tag movement information indicate the same time are both satisfied.

When the tag movement information is received from the tag 3 (OP107: YES), the process proceeds to OP108. When the tag movement information is not received from the tag 3 (OP107: NO), the process proceeds to OP104.

In OP108, the monitoring unit 12 creates the behavior history information including the identification information of the target shopper and the type of behavior event detected in OP104, and stores the information in the behavior history information DB 15. After that, the process proceeds to OP104.

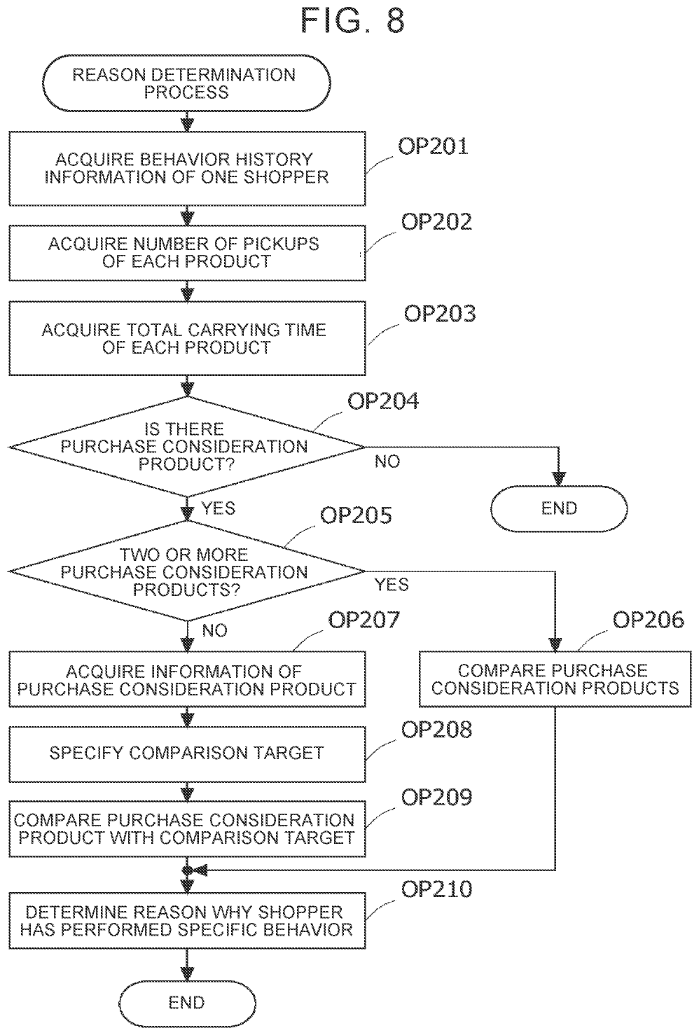

FIG. 8 is an example of a flowchart of a reason determination process of the center server 1. The process shown in FIG. 8 is started at a predetermined timing. The predetermined timing is a predetermined time once a day, or is triggered by input of a start instruction, etc. The target of the process shown in FIG. 8 is the behavior history information that has not been processed at the start of the process shown in FIG. 8. The process shown in FIG. 8 is executed for each shopper.

In OP201, the control unit 11 extracts the behavior history information on one shopper from the behavior history information DB 15. The behavior history information on the one shopper refers to the behavior history information including the identification information of the same shopper in the first embodiment.

In OP202, the control unit 11 acquires the number of times the shopper picks up the product from the behavior history information extracted in OP201. For example, the number of pieces of the behavior history information having the same tag ID and type of behavior event “pickup” may be used as the number of times the shopper picks up the product.

In OP203, the control unit 11 acquires the total carrying time of each product from the behavior history information extracted in OP202. For example, from the occurrence date and time of the behavior history information in which the type of behavior event is “pickup” and the behavior history information in which the type of behavior event is “return”, both having the same tag ID, the carrying time of the product to which the tag 3 having the tag ID is attached can be acquired. When the shopper picks up and returns the same product multiple times, there is a plurality of pieces of the behavior history information in which the type of the behavior event is “pickup” and the behavior history information in which the type of the behavior event is “return”, both having the same ID. In this case, a piece of the behavior history information in which the type of behavior event is “pickup” and a piece of the behavior history information in which the type of behavior event that is “return” and occurs subsequent to the piece of the behavior history information in which the type of the behavior event is “pickup” in terms of time and that has the same tag ID as that of the piece of behavior history information in which the type of the behavior event is “pickup” are handled as a set, and a difference in time of each set is calculated.

In OP204, the control unit 11 determines whether there is a purchase consideration product. That is, in OP204, the control unit 11 determines whether the shopper has performed a specific behavior for a predetermined product. For example, the control unit 11 determines that any product that satisfies at least any one of the following conditions is the purchase consideration product: the number of pickups acquired in OP202 is equal to or more than a predetermined number of times; and the total value of the carrying time calculated in OP203 is equal to or more than a predetermined time or a ratio of the total value of the carrying time calculated in OP203 to the staying time from the entry to the exit from the store is equal to or more than a predetermined value. When there is a purchase consideration product (OP204: YES), the process proceeds to OP205. When there is no purchase consideration product (OP204: NO), the process shown in FIG. 8 ends.

In OP205, the control unit 11 determines whether there are two or more purchase consideration products. When there are two or more purchase consideration products (OP205: YES), the process proceeds to OP206. In OP206, the control unit 11 acquires, for example, the difference in each attribute between the purchase consideration products as a comparison between the purchase consideration products. Information on each purchase consideration product is acquired from the product information DB 13.

When there is one purchase consideration product (OP205: NO), the process proceeds to OP207. In OP207, the control unit 11 acquires the information on the purchase consideration product from the product information DB 13. In OP208, the control unit 11 specifies the comparison target. In OP209, the control unit 11 compares the purchase consideration product with the comparison target, and acquires, for example, the difference in each attribute.

In OP210, the control unit 11 determines the reason why the shopper has performed a specific behavior for the purchase consideration product. For example, the control unit 11 may determine an attribute having a difference larger than a predetermined value as the reason why the shopper has performed a specific behavior for the purchase consideration product. When there is a plurality of attributes having a difference larger than a predetermined value, the control unit 11 may determine the predetermined number of attributes having large difference in the descending order as the reason. When there are three or more purchase consideration products, the control unit 11 may compare each combination of two purchase consideration products and determine the attribute with the large number of combinations of two purchase consideration products having a difference equal to or larger than a predetermined value as the reason. After that, the acquired reason may be output to a predetermined device. After that, the process shown in FIG. 8 ends.

Note that FIG. 8 shows a flowchart when batch processing is executed at a predetermined timing. The reason why the shopper hesitates to purchase the product can be determined in real time. In that case, for example, the control unit 11 monitors the behavior history information, measures the number of times the product is picked up or the carrying time, and executes the processes in OP205 and later when the control unit 11 determines that the shopper is hesitant to purchase the product.

Further, in the process shown in FIG. 8, when there are two or more purchase consideration products, comparison is performed between the purchase consideration products. However, instead of this, the comparison target may be specified for each of the purchase consideration products, and the purchase consideration product may be compared with the specified comparison target. In this case, the attribute with the largest number of purchase consideration products having a difference equal to or larger than a predetermined value in the comparison with the comparison target may be determined as the reason why the shopper has performed a specific behavior for the purchase consideration product.

With the processes shown in FIG. 8, the reason why one shopper performs a specific behavior for the product is determined. For example, collection of statistics based on the determination results of the reason why a plurality of the shoppers performs a specific behavior for the product makes it possible to identify the overall tendency.

### Action Effect of First Embodiment

According to the first embodiment, the reason why the shopper hesitates to purchase the product can be estimated by detecting a specific behavior of the shopper for the product and determining the reason why the shopper performs a specific behavior. In other words, the reason why the shopper hesitates to purchase the product is a factor for making a purchase decision. Therefore, determination of the reason why the shopper hesitates to purchase the product makes it possible to utilize the reason for advertising and customer service for promoting the purchase decision of the shopper, development of a new product, etc.

Further, in the first embodiment, for example, the personal information that identifies an individual such as a name, an address, and purchase history information is not used. Therefore, the privacy of the shopper is not infringed.

### Second Embodiment

In the first embodiment, the reason why the shopper has performed a specific behavior is determined using the information related to the product for which the shopper has performed a specific behavior. In a second embodiment, in addition to this, the reason why the shopper has performed a specific behavior is determined using information related to the shopper. For example, there is a tendency in orientation of products depending on the attributes of the shopper. Therefore, it is possible to perform more detailed analysis using the information related to the shopper. In the second embodiment, the description overlapping with the first embodiment will be omitted.

The second embodiment has the same system configuration and the hardware configuration of each device as the first embodiment. The functional configuration is different in that the center server 1 includes the shopper attribute information DB 16 and the orientation information DB 17. In the second embodiment, the monitoring unit 12 specifies the attributes of the shopper from the image captured by the camera 2, for example, by image recognition processing. The attributes of the shopper that can be specified by the image recognition processing, that is, the attributes of the shopper that can be acquired from the appearance are, for example, gender and age. The monitoring unit 12 stores information regarding the attributes of the shopper in the shopper attribute information DB 16.

The control unit 11 uses the orientation information corresponding to the attributes of the shopper as the comparison target of the purchase consideration product. The orientation information is, for example, a standard value for each attribute of the product in accordance with gender and age. The control unit 11 acquires a difference between the purchase consideration product and the orientation information and specifies the reason why the shopper hesitates to purchase the product based on the difference.

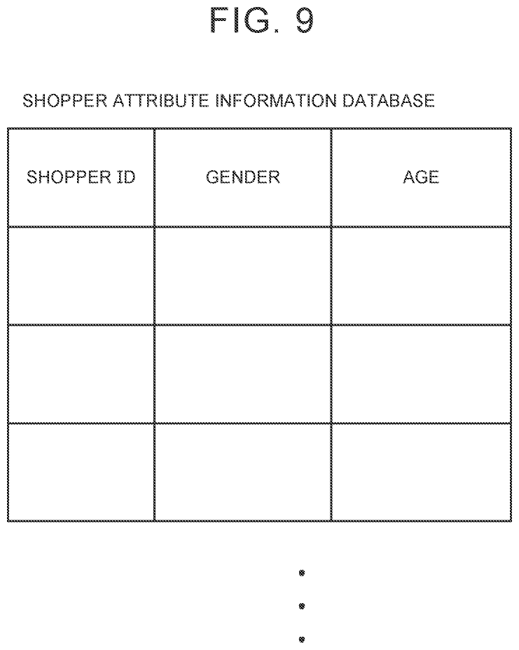

FIG. 9 is a diagram showing an example of the data structure of the shopper attribute information DB 16. The shopper attribute information DB 16 is created in the storage area of the external storage device 103 of the center server 1. The shopper attribute information DB 16 stores information related to the attributes of the shopper.

The entry of the shopper attribute information DB 16 includes fields of the shopper ID, gender, and age. The identification information of the shopper assigned by the center server 1 is stored in the shopper ID field. The gender of the shopper acquired from the image recognition processing of the image captured by the camera 2 is stored in the gender field. The age of the shopper acquired from the image recognition processing of the image captured by the camera 2 is stored in the age field. The ages are, for example, teens, twenties, thirties, forties, . . . and so on. The data structure of the shopper attribute information DB 16 is not limited to that shown in FIG. 9.

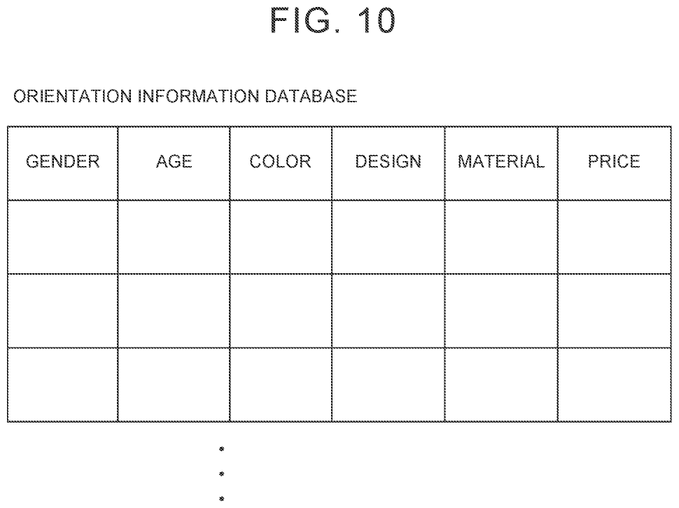

FIG. 10 is a diagram showing an example of the data structure of the orientation information DB 17. The orientation information DB 17 is created in the storage area of the external storage device 103 of the center server 1. The orientation information DB 17 stores a standard value of each attribute in accordance with gender and age.

The entry in the orientation information DB 17 includes fields for gender, age, color, design, material, and price. The color, design, material, and price correspond to the product attributes. The standard value is stored in each field of the color, design, material, and price. The standard value of the attribute is acquired in advance. The standard value of each attribute is acquired by, for example, statistics. In the data structure of the orientation information DB 17, the fields corresponding to the attributes differ depending on what the product is.

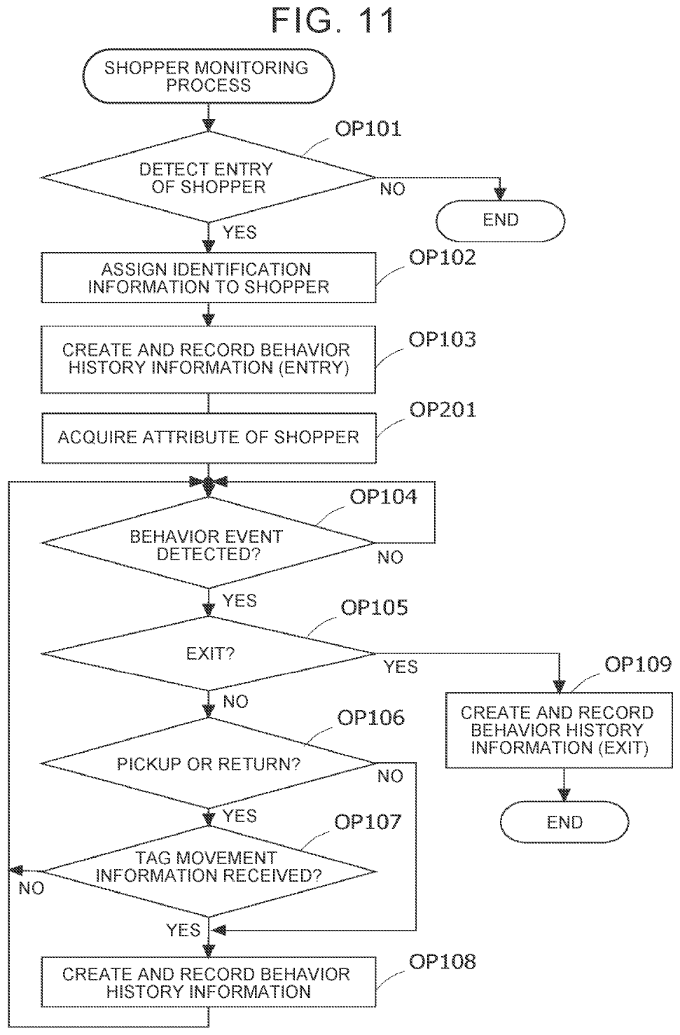

FIG. 11 is a flowchart of the shopper monitoring process of the center server 1 according to the second embodiment. In the shopper monitoring process shown in FIG. 11, in addition to the shopper monitoring process shown in FIG. 7 in the first embodiment, a process for acquiring the attributes of the shopper in OP201 is added. In OP201, the monitoring unit 12 executes image recognition processing of the image captured by the camera 2, acquires the gender and age of the target shopper, and stores the attribute in the shopper attribute information DB 16. Other processes are the same as those shown in FIG. 7.

In the second embodiment, the flowchart of the reason determination process of the center server 1 is the same as that shown in FIG. 8. However, in the process of specifying the comparison target in OP208, the attribute of the shopper is acquired from the shopper attribute information DB 16, and the orientation information corresponding to the attribute of the shopper is specified as the comparison target.

In the second embodiment, the reason why the shopper hesitates to purchase the product can be determined in consideration of the attributes of the shopper using the orientation information corresponding to the attributes of the shopper as the comparison target. For example, depending on the gender and age, there is a tendency for the reason why the shopper hesitates to purchase the product. Therefore, it is possible to determine the reason that is closer to the reason why the shopper actually hesitates to purchase the product. In addition, when the reason why the shopper hesitates to purchase the product, which is acquired through the determination, is used for sales promotion, a countermeasure corresponding to the attributes of the shopper can be implemented.

In the second embodiment, the comparison target is specified using the attribute that can be acquired from the image captured by the camera 2. However, instead of this, the comparison target may be specified using the purchase history of the shopper at the store A. When the purchase history of the shopper at the store A is used, the center server 1 acquires, for example, the purchase history information on the customer managed by the store A.

Specifically, for example, when a customer in the store A purchases a product, the customer presents a member's card, and a payment settlement terminal such as a cash register in the store A reads the identification information of the customer from the member's card. At this time, the identification information of the customer is transmitted from the payment settlement terminal of the store A to the center server 1, and the center server 1 acquires the purchase history information with respect to the identification information of the customer from the server in the store A. The center server 1 links the purchase behavior of the shopper detected from the image captured by the camera 2 with the identification information of the customer from the terminal in the store A. The center server 1 may specify, for example, a product of the same type as the purchase consideration product as the comparison target based on the purchase history information on the customer. A method of acquiring and a method of using the purchase history information on the customer are not limited to this.

### Other Embodiments

The above-described embodiment is merely an example, and the present disclosure may be appropriately modified and implemented without departing from the scope thereof.

In the first embodiment, it is assumed that the tag 3 is attached to the hanger on which the clothes that is the product is hung. However, the sensor for detecting that the product is picked up is not limited to the tag 3. For example, when it is possible to specify the behavior such as pickup of the product and the product that is picked up from the image captured by the camera 2, the camera 2 may be used as a sensor for detecting that the product is picked up, etc.

Alternatively, the tag 3 may be attached to the product itself. In addition, picking up of the product may be detected by causing the shopper to carry a scanner that reads the information of the tag attached to the product and to read the tag of the product using the scanner when the shopper picks up the product.

Alternatively, a radio frequency (RF) tag may be attached to the product and picking up of the product may be detected using an RF reader provided around each product, and then the RF reader may transmit the tag movement information to the center server 1.

Further, in the first embodiment and the second embodiment, the purchase consideration product is specified regardless of whether the product is actually purchased. Alternatively, the purchased product may be excluded from the target of specifying the purchase consideration product. That is, the purchase consideration product may be specified from the products that are not purchased.

Further, one purchase consideration product may be compared with a plurality of the purchase consideration products and the reason why the shopper has performed a specific behavior for the one purchase consideration product may be determined based on the comparison result with each comparison target. For example, in combination of the first embodiment and the second embodiment, the product that is the comparison target and the orientation information corresponding to the attributes of the shopper may be compared for one purchase consideration product, and the attribute with which the average difference becomes the largest, or the attribute with which the number of times that the difference becomes largest in the comparison result with the comparison target may be determined as the reason why the shopper has performed a specific behavior for the purchase consideration product.

The processes and means described in the present disclosure can be freely combined and implemented as long as no technical contradiction occurs.

Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function.

The present disclosure can also be implemented by supplying a computer with a computer program that implements the functions described in the above embodiments, and causing one or more processors of the computer to read and execute the program. Such a computer program may be provided to the computer by a non-transitory computer-readable storage medium connectable to the system bus of the computer, or may be provided to the computer via a network. The non-transitory computer-readable storage medium is, for example, a disc of any type such as a magnetic disc (floppy (registered trademark) disc, hard disk drive (HDD), etc.), an optical disc (compact disc read-only memory (CD-ROM), digital versatile disc (DVD), Blu-ray disc, etc.), a read only memory (ROM), a random access memory (RAM), an erasable programmable read only memory (EPROM), an electrically erasable programmable read only memory (EEPROM), a magnetic card, a flash memory, an optical card, and any type of medium suitable for storing electronic commands.

What is claimed is:

1. An information processing device comprising a control unit configured to execute:
detection that a first shopper has performed a specific behavior for a first product based on information acquired by a sensor; and
determination of a reason why the first shopper has performed the specific behavior for the first product based on information related to the first product and at least one of information related to a second product that is a comparison target of the first product and information related to the first shopper.

2. The information processing device according to claim 1, wherein the control unit is configured to determine the reason based on an attribute that makes a difference between the first product and the second product when the control unit determines the reason based on the information related to the first product and the information related to the second product.

3. The information processing device according to claim 1, wherein the control unit is configured to specify, as the second product, another product for which the first shopper has performed the specific behavior.

4. The information processing device according to claim 1, wherein the control unit is configured to specify, as the second product, a product displayed around the first product.

5. The information processing device according to claim 1, wherein the control unit is configured to specify, as the second product, a product that is preset as a comparison target of the first product.

6. The information processing device according to claim 1, wherein the control unit is configured to determine the reason based on an attribute that makes a difference between the first product and an orientation indicated by the information related to the first shopper when the control unit determines the reason based on the information related to the first product and the information related to the first shopper.

7. The information processing device according to claim 1, wherein the control unit is configured to further execute acquisition of attribute information on the first shopper acquired from an appearance as the information related to the first shopper based on an image including the first shopper, the image being captured by a camera serving as the sensor.

8. The information processing device according to claim 1, wherein the control unit is configured to further execute acquisition of purchase history information on the first shopper as the information related to the first shopper.

9. The information processing device according to claim 1, wherein the control unit is configured to detect that the first shopper has performed the specific behavior for the first product when the number of times that the first shopper picks up the first product is equal to or more than a threshold, the number of times being indicated by the information acquired by the sensor.

10. The information processing device according to claim 1, wherein the control unit is configured to detect that the first shopper has performed the specific behavior for the first product when a total time during which the first shopper carries the first product is equal to or more than a threshold, the total time being indicated by the information acquired by the sensor.

11. An information processing method comprising:
detecting that a first shopper has performed a specific behavior for a first product based on information acquired by a sensor; and
determining a reason why the first shopper has performed the specific behavior for the first product based on information related to the first product and at least one of information related to a second product that is a comparison target of the first product and information related to the first shopper.

12. The information processing method according to claim 11, wherein when the reason is determined based on the information related to the first product and the information related to the second product, the reason is determined based on an attribute that makes a difference between the first product and the second product.

13. The information processing method according to claim 11, wherein another product for which the first shopper has performed the specific behavior is specified as the second product.

14. The information processing method according to claim 11, wherein a product displayed around the first product is specified as the second product.

15. The information processing method according to claim 11, wherein a product that is preset as a comparison target of the first product is specified as the second product.

16. The information processing method according to claim 11, wherein when the reason is determined based on the information related to the first product and the information related to the first shopper, the reason is determined based on an attribute that makes a difference between the first product and an orientation indicated by the information related to the first shopper.

17. The information processing method according to claim 11, further comprising acquiring attribute information on the first shopper acquired from an appearance as the information related to the first shopper based on an image including the first shopper, the image being captured by a camera serving as the sensor.

18. The information processing method according to claim 11, further comprising acquiring purchase history information on the first shopper as the information related to the first shopper.

19. The information processing method according to claim 11, wherein it is detected that the first shopper has performed the specific behavior for the first product when the number of times that the first shopper picks up the first product is equal to or more than a threshold, the number of times being indicated by the information acquired by the sensor.

20. The information processing method according to claim 11, wherein it is detected that the first shopper has performed the specific behavior for the first product when a total time during which the first shopper carries the first product is equal to or more than a threshold, the total time being indicated by the information acquired by the sensor.
